(19) United States
(12) Patent Application Publication
(10) Pub. No.: US 2012/0240799 A1
(43) Pub. Date: Sep. 27, 2012

(54) INK FOUNTAIN LINER AND BLADE GUARD

(76) Inventor: Ronald E. Fuller, Overland Park, KS (US)

(21) Appl. No.: 13/052,571

(22) Filed: Mar. 21, 2011

(51) Int. Cl. B41F 35/00

(52) U.S. Cl. 101/425

(57) ABSTRACT

The present invention is an ink fountain liner and blade guard adapted for prolonging the life of an ink fountain blade and controlling the temperature of the ink by eliminating metal to metal friction and reducing cleaning time and cleaning materials. The liner covers the bottom surface of an ink fountain and includes a strip of double sided adhesive with a backing strip preserving the side of the adhesive not affixed to the liner. The front edge of the preferred embodiment is connected at a creased line to a flap that covers the ink fountain blade.

### BACKGROUND OF THE INVENTION

1. Field of the Invention

The present invention relates generally to ink fountain liners used in offset printing presses, and more particularly to a method of utilizing liners for eliminating metal to metal friction, prolonging the life of a fountain blade, controlling ink temperature, and reducing cleaning time and materials.

2. Description of the Related Art

Offset presses are used for a variety of printing processes, for example, dry offset presses are used in the plastics printing industry. In an offset press, a viscous ink is placed in an ink fountain, which then delivers the ink into the printing press by way of ink rollers. A typical ink fountain has two side walls containing the ink and a bottom panel forming a blade that slopes towards the ink roller. A small clearance between the blade edge and the ink roller defines a nip. The size of the nip can be increased or decreased by adjusting the distance between the blade edge and the ink roller. The size of the nip dictates how much ink enters the press, which is based on the amount of ink needed for a specific printing job.

When a printing job demands only a small amount of ink, the nip is adjusted to a minimal clearance. This can result in the blade edge and the ink roller coming into contact with each other. This metal on metal contact can be detrimental to the printing process in several ways. The metal to metal friction can wear down the blade edge at points of contact causing irregularities in the width of the blade edge, which results in a decreased life of the blade. The friction can also raise the temperature of the ink which affects the viscosity of the ink, and in turn the quality of the print job.

When an ink color change is needed or the ink otherwise needs to be replaced, it is often necessary to clean the ink fountain. Cleaning the ink fountain commonly involves scraping out the residual ink with a spatula-type instrument. The ink fountain is then wiped clean with a solvent-soaked rag to remove any remaining ink. This cleaning process can become costly because of both the labor hours it demands and the products it requires. Cleaning the ink fountain is still necessary even when using prior art ink fountain liners because they allow “ink intrusion” to occur. Ink intrusion occurs when ink is able to get between the liner and the ink fountain at the liner's edge adjacent the nip. Ink intrusion occurs when there is an imperfect placement of the liner's edge adjacent the nip or when there is an uneven fountain bottom surface. The roller creates shear forces in the highly viscous ink as part of it is drawn through the nip by adherence to the ink roller. These shear forces create a rotating vortex in the remaining ink in the fountain. The pumping effect from this vortex tends to lift the liner's edge and/or force ink into even the smallest opening between the liner and the fountain, thus necessitating cleaning.

The present invention provides a tray liner forming a barrier between the ink fountain blade edge and the ink roller. With the ink fountain liner forming a barrier between the blade edge and the ink roller, all metal to metal friction is eliminated. The elimination of this friction prevents irregularities from forming in the blade and the temperature of the ink from rising. In addition to preventing new irregularities from forming on the blade edge, the ink fountain liner acts as a resurfacing material for the blade edge by providing a smooth cover over existing irregularities in the blade edge. The barrier formed by the ink fountain liner also prevents ink from touching the surfaces of the ink fountain or the blade. The process of cleaning an ink fountain is thus generally reduced to removing the ink fountain liner and replacing it with a new one.

The advantages of the present invention over the prior art include elimination of metal to metal friction between the ink fountain blade and the ink roller, prolonged life of the ink fountain blade, elimination of ink intrusion and controlled ink temperature. It should be noted that the present invention is not, however, limited to any or all of these advantages, or to the disclosed application.

Heretofore there has not been available an ink fountain liner method and system with the advantages and features of the present invention.

### SUMMARY OF THE INVENTION

In the practice of the present invention an ink fountain liner is provided for an offset press. Without limitation, the liner is adapted for prolonging the life of an ink fountain blade by preventing irregularities from forming on the blade and by acting as a resurfacing material for a previously damaged blade and controlling the temperature of the ink by eliminating metal to metal friction and reducing cleaning time and cleaning materials. The liner covers the bottom surface of an ink fountain and includes an adhesive, such as a strip of double sided adhesive tape, with a backing strip preserving the adhesive on the side of the tape not affixed to the liner. A front edge of a bottom panel is connected at a creased line to a flap that covers and overlaps the end of the ink fountain blade, which prevents ink intrusion into any possible space between the ink fountain blade and the liner.

### BRIEF DESCRIPTION OF THE DRAWINGS

The drawings constitute a part of this specification and include exemplary embodiments of the present invention illustrating various objects and features thereof

FIG. 1 is an isometric diagram of an ink fountain liner and blade guard placed in an ink fountain engaged with an ink roller in an offset printing press.

FIG. 2 is an exploded isometric view of the ink fountain liner and blade guard and the ink fountain engaged with an ink roller in an offset printing press.

FIG. 3 is a sectional view of an ink fountain liner and blade guard placed in an ink fountain engaged with an ink roller taken along cut line 3 in FIGS. 1 and 2.

FIGS. 4A and 4B are detail sectional views taken generally within the circle shown in FIG. 3.

FIG. 5 is an isometric view of the preferred embodiment of the ink fountain liner and blade guard with a front flap.

FIG. 6 is an isometric view of the bottom of the preferred embodiment.

FIG. 7 is an isometric view of an alternative embodiment of the ink fountain liner and blade guard without a front flap.

FIG. 8 is an isometric view of an alternative embodiment of the ink fountain liner and blade guard with a front and back flap.

FIG. 9 is an isometric view of an alternative embodiment of the ink fountain liner and blade guard with front and back flaps and side flaps.

### DETAILED DESCRIPTION OF THE DRAWINGS

### I. Introduction and Environment

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Said terminology will include the words specifically mentioned, derivatives thereof and words of similar meaning.

Referring to the drawings in more detail, the reference numeral 2 generally designates an ink fountain liner and blade guard embodying an aspect of the present invention. Without limitation on the range of useful applications of the ink fountain liner and blade guard 2 comprising the present invention, an exemplary application is disclosed comprising a panel 4 connected to a front flap 6 at a creased line 8. A double sided adhesive strip 10 is affixed to the bottom surface 7 (FIG. 6) of the panel 4 with a backing strip 12 covering the adhesive layer on the bottom of the strip 10. The adhesive strip 10 can be of any suitable width. Without limitation on the generality of materials that can be used with the present invention, a suitable material for the liner is clear polyester sheeting from Ridout Plastics of San Diego, Calif. Without limitation on the generality of adhesives that can be used with the present invention, a suitable adhesive is Cactus No. Y291M Double-Coated Adhesive Tape from V. Himark (USA) Inc. of Irwindale, Calif.

### II. Preferred Embodiment or Aspect of the Ink Fountain Liner and Blade Guard 2

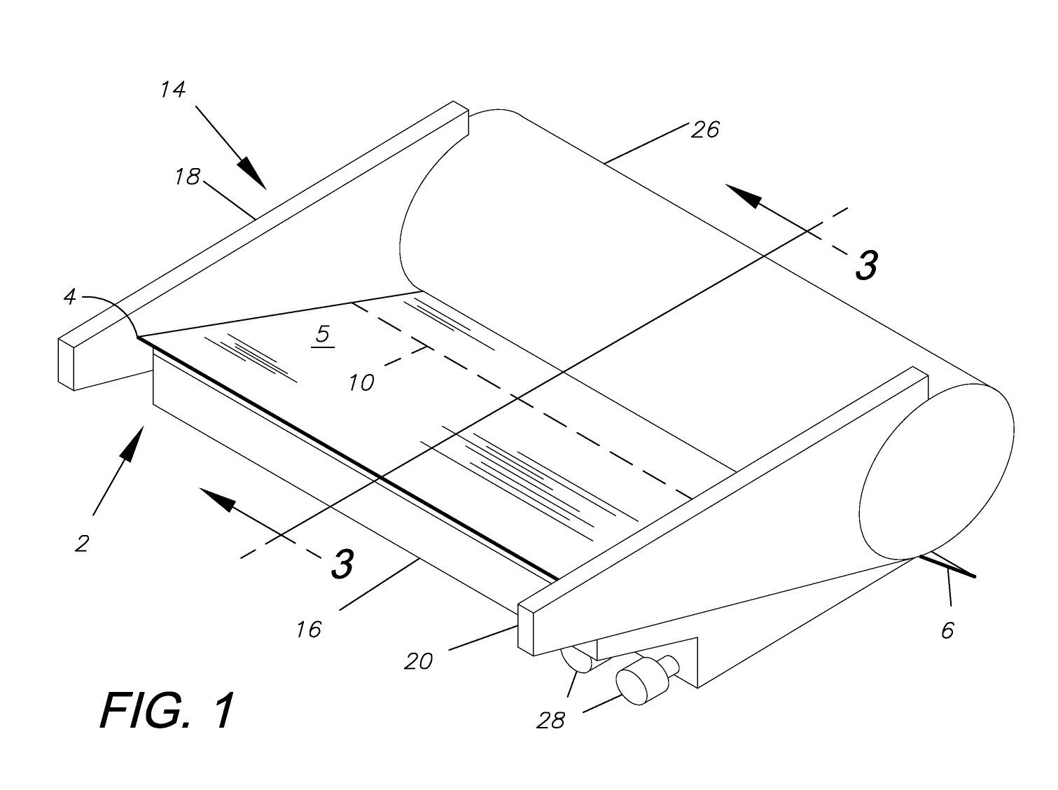

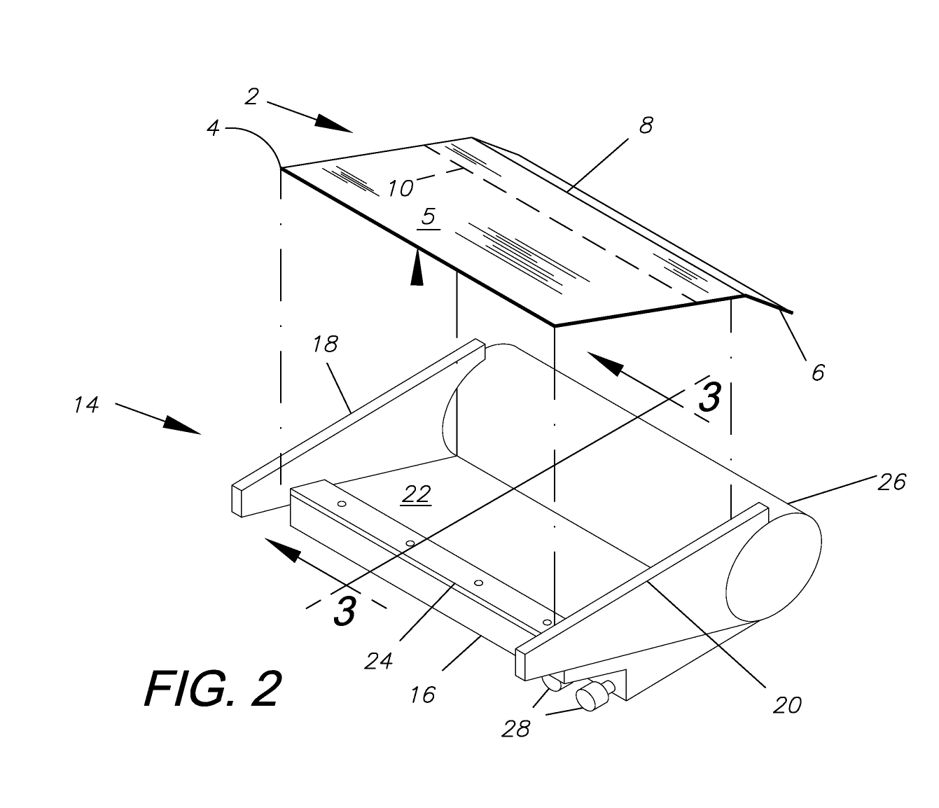

As shown in FIGS. 1-2, the ink fountain 14 generally comprises a base 16, a left sidewall 18, a right sidewall 20, a blade 22, and a blade retainer 24. The blade retainer 24 keeps the blade 22 in place during use and can be removed for maintenance or replacement of the blade 22. The ink fountain 14 is engaged with an ink roller 26, with the left 18 and right 20 sidewalls of the ink fountain 14 closely adjacent or contacting the ink roller 26.

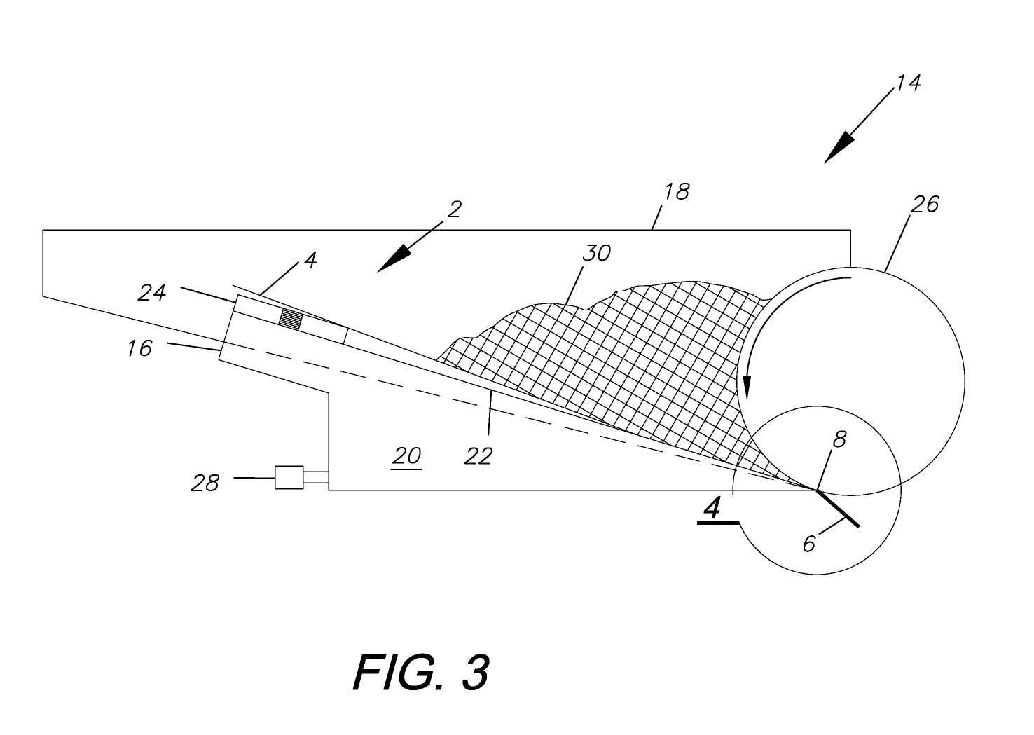

FIG. 3 is a sectional view of the present invention and the surrounding environment along section line 3 as shown in FIGS. 1-2. The ink fountain 14 is partly filled with ink 30, which is contained by a top surface 5 of the panel 4 and the ink roller 26.

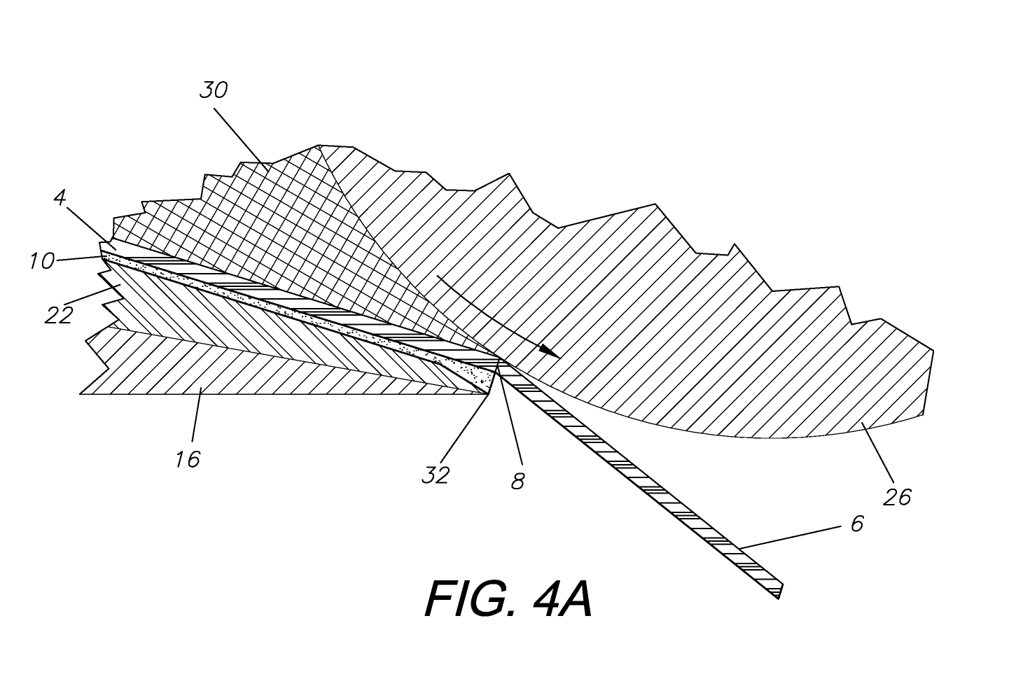

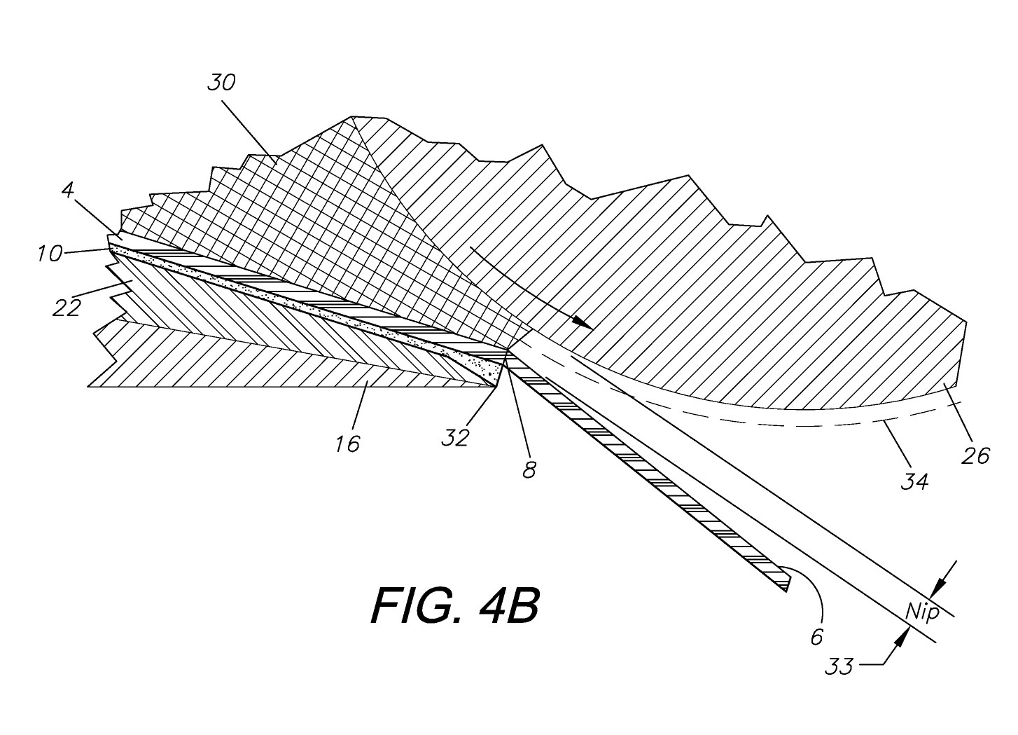

FIGS. 4A and 4B are enlarged, sectional views taken generally within Circle 4 in FIG. 3. As shown in FIG. 4A, the front flap 6 acts as a barrier between the blade edge 32 and the ink roller 26. Because the front flap 6 keeps the blade edge 32 and the ink roller 26 from touching, there is no metal-on-metal friction between the blade edge 32 and the ink roller 26, which prevents the ink 30 temperature from increasing and prolongs the life of the blade 22 by preventing irregularities from forming due to contact with the ink roller 26. The blade edge 32 comes in contact with the ink roller 26 when adjustment screws 28 in the base 16 of the ink fountain 14 are tightened to apply pressure at a given point on the blade edge 32. As shown in FIG. 4B, loosening the screws 28 results in a nip 33 between the blade edge 32 and the ink roller 26. The ink roller 26 turns counter-clockwise as viewed from its right side (FIGS. 3, 4A and 4B). Ink on the roller 34 passes through the nip and into the offset press.

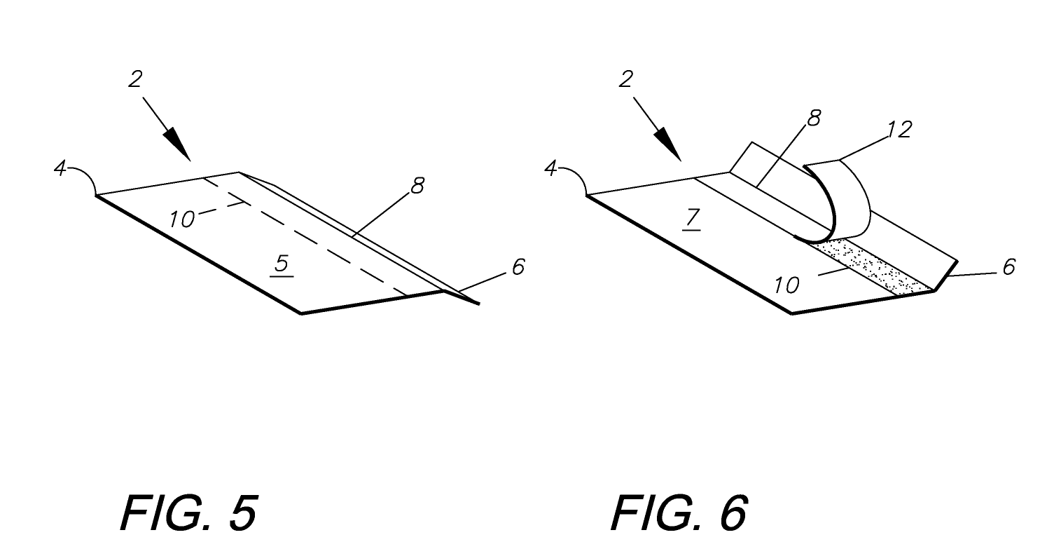

FIG. 5 is an isometric view of the top of the preferred embodiment of the ink fountain liner and the blade guard 2. FIG. 6 is an isometric view of the bottom surface 7 of the ink fountain liner and blade guard 2. The backing strip 12 is peeled away and the adhesive strip 10 is pressed onto the blade 22 to hold the ink fountain liner and blade guard 2 in position on the ink fountain 14.

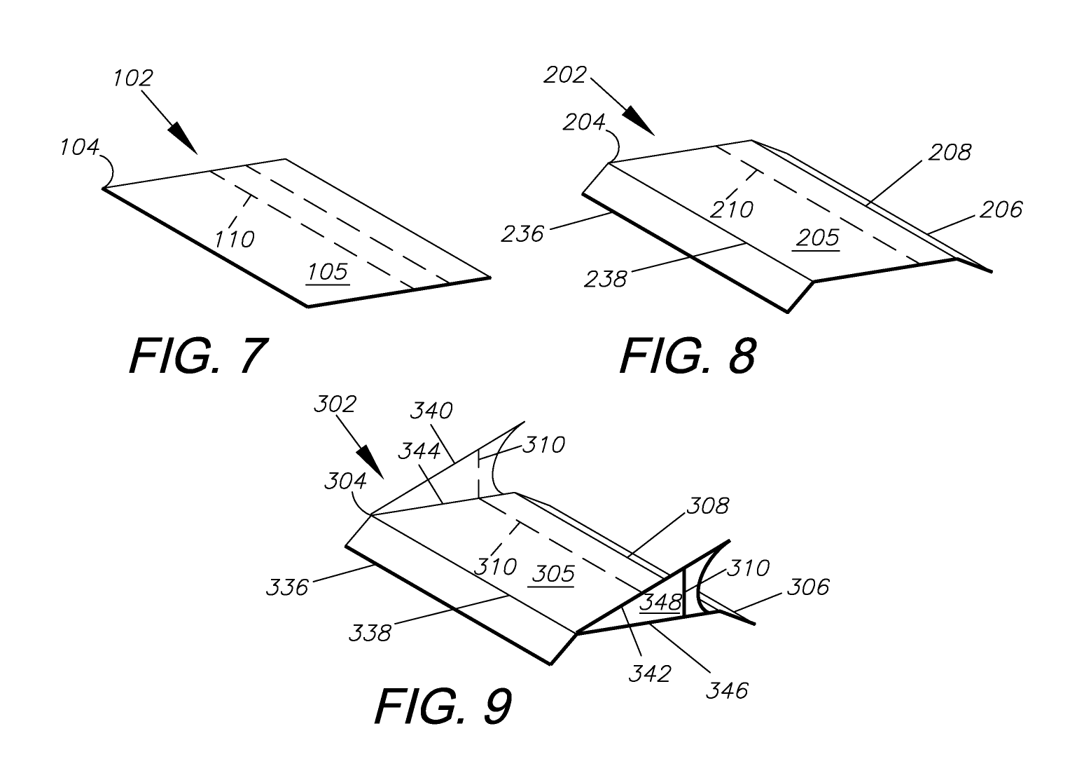

FIG. 7 is an isometric view of an alternative embodiment ink fountain liner and blade guard 102 comprising a flat panel 104, a top surface 105, i.e. without a crease, and an adhesive strip 110.

FIG. 8 is an isometric view of another alternative embodiment ink fountain liner and blade guard 202, a flat panel 204, a top surface 205 with a double-sided adhesive strip 210, and a front flap 206 with a crease 208. A rear flap 236 is connected to the panel 34 at a creased line 238. The rear flap 236 can be used to wipe an ink-handling tool after adding or removing ink 30 from the ink fountain 14.

FIG. 9 is an isometric view of another alternative embodiment ink fountain liner and blade guard 302. The panel 304 has a top surface 305, a front flap 306, connected at creased line 308, a rear flap 336, connected at creased line 338, a left flap 340, and a right flap 342 connected at creased lines 344, 346. A double-sided adhesive strip 310 is affixed to the outer surface 348 of the side flaps 340, 342 with a backing strip 12 covering the adhesive on the side of the tape not affixed to the outer surface 348. The side flaps 340, 342 keep ink from getting on the left 18 and right 20 sidewalls of the ink fountain 14.

It will be appreciated that the ink fountain liner and blade guard can be used for various applications not described herein. Moreover, the ink fountain liner and blade guard can be constructed of additional elements or alternative elements to those mentioned herein, while providing similar results.

It is to be understood that while certain aspects of the disclosed subject matter have been shown and described, the disclosed subject matter is not limited thereto and encompasses various other embodiments and aspects.

Having thus described the invention, what is claimed as new and desired to be secured by Letters Patent is:

1. A combination liner and blade guard for protecting a blade edge of an ink fountain for an offset printing presses, which combination liner and blade guard includes:
a panel comprising a top face and a bottom face;
a double-sided adhesive strip comprising first and second sides, the first side of said adhesive strip being connected to the bottom face of said panel; and
said adhesive strip second side being adapted for releasable connection to said ink fountain whereby said combination liner and blade guard are removably mounted in said ink fountain.

2. The combination liner and blade guard according to claim 1, wherein said combination liner and blade guard is further comprised of a front flap connected to said panel at a creased line.

3. The combination liner and blade guard according to claim 1, wherein said liner and blade guard is comprised of clear polyester.

4. The combination liner and blade guard according to claim 1, wherein said adhesive strip is comprised of double-sided adhesive tape with a removable backing strip on said second side.

5. The combination liner and blade guard according to claim 1, further comprising a rear flap connected to said panel at a creased line.

6. The combination liner and blade guard according to claim 1, further comprising side flaps connected to said panel at creased lines.

7. A method of protecting a blade edge of an ink fountain, the method including the steps of:
providing a printing press with an ink fountain;
providing a combination ink fountain liner and blade guard comprising a panel and a front flap connected to said panel at a creased line;
providing an adhesive strip attached to a bottom surface of said panel;
initially providing said adhesive strip with a backing strip covering an exposed side of said adhesive strip;
removing said backing strip from and thereby exposing said adhesive strip;
placing said liner into said ink fountain over said blade edge with said creased line located adjacent to said blade edge;
extending said front flap distally away from said blade edge;
engaging said adhesive strip with said ink fountain whereby said combination ink fountain liner and blade guard is releasably secured in said ink fountain;
placing ink in said ink fountain on said ink fountain liner and blade guard;
shielding said ink fountain from said ink with said ink fountain liner and blade guard;
forming between said creased line and a transfer roller of said offset printing press a nip comprising an adjustable clearance;
adjusting said nip for optimum ink flow in a printing operation;
running said offset printing press;
dispensing ink from said ink fountain and onto the transfer roller of said offset printing press;
disengaging the adhesive strip from said ink fountain; and
removing said ink fountain liner and blade guard with the remaining ink in said ink fountain.

8. The method of claim 7 wherein said liner is comprised of clear polyester.

9. The method of claim 7 wherein said adhesive is comprised of double coated adhesive tape.

10. A rotary offset printing press with lined ink fountains, which press comprises:
an ink roller including a cylindrical surface adapted for transferring ink;
an ink fountain including:
a base;
a pair of sidewalls each connected to the base and extending upwardly therefrom;
multiple adjustment screws connected to the base;
a blade retainer attached to the base;
a metallic blade mounted on the base by the blade retainer;
a combination liner and blade guard seated on the blade;
each said ink fountain sidewall including a front edge conforming to the ink roller surface;
said blade including a blade edge aligned with the ink roller surface;
said multiple adjustment screws adapted for moving the blade edge into proximity with the ink roller surface;
said combination liner and blade guard including: a panel; a double-sided adhesive strip; a front flap; a contact position; and a flow position;
said panel comprising a top surface and a bottom surface;
said double-sided adhesive strip connected to the bottom surface of said panel and the blade for mounting said liner and blade guard on said blade;
said combination liner and blade guard front flap being connected to said panel at a creased line;
said creased line aligned with the ink fountain blade edge;
said combination liner and blade guard contact position comprising tightened adjustment screws in the ink fountain base causing the creased line to contact the ink roller surface;
said combination liner and blade guard flow position comprising the adjustment screws in the ink fountain base being in loosened positions placing the creased line in spaced relation from the ink roller surface and thereby creating and adjustable-clearance nip between the creased line and the ink roller surface adapted for adjusting a flow of ink through said nip;
said nip comprising the space defined by the creased line, the ink fountain sidewalls, and the ink roller;
said combination liner and blade guard being comprised of clear polyester; and
said adhesive comprised of double coated adhesive tape.

11. The combination liner and blade guard according to claim 10, further comprising a rear flap connected to said panel at a rear flap creased line.

12. The combination liner and blade guard according to claim 10, further comprising side flaps connected to said panel at respective side flap creased lines.
